(19) United States
(12) Patent Application Publication
(10) Pub. No.: US 2013/0280530 A1
(43) Pub. Date: Oct. 24, 2013

(54) TWO-COMPONENT CURABLE COMPOSITION

(71) Applicant: Henkel AG & Co. KGaA, Duesseldorf (DE)

(72) Inventors: Jens Luckert, Barsinghausen (DE); Lars Zander, Neuotting (DE); Eric Rozier, Saint-Didier de Formans (FR); Florent Villemagne, Villefrance/saone Frankreich (FR)

(21) Appl. No.: 13/838,447

(22) Filed: Mar. 15, 2013

Related U.S. Application Data
(63) Continuation of application No. PCT/EP2011/071006, filed on Nov. 25, 2011.

(30) Foreign Application Priority Data
Nov. 30, 2010 (DE) 102010062186.2

(51) Int. Cl. C09J 171/00; C09D 171/00

(52) U.S. Cl. CPC C09J 171/00; C09D 171/00
USPC 428/355 N; 524/588

(57) ABSTRACT

In the context of a curable agent based on at least one silyl-terminated polymer, the adhesion spectrum for bonding plastics, and the speed at which adhesion builds up, are to be improved. This is achieved by making available a curable agent containing two components (1) and (2) that are not in mutual contact, where component (1) contains at least one polymer having at least one terminal group of formula (I) -Aₙ-CH₂—SiXYZ (I), in which A is a divalent bonding group, X, Y, Z are, mutually independently, are C₁ to C₈ alkyl, C₁ to C₈ alkoxy, or C₁ to C₈ acyloxy groups, where at least one of the substituents is a C₁ to C₈ alkoxy or C₁ to C₈ acyloxy group, and n is 0 or 1; and component (2) contains at least water and at least one silanol condensation catalyst. A further subject of the present invention is the use of the agent according to the present invention as an adhesive and/or sealant.

The present invention is in the sector of curable agents such as those found, for example, in adhesives, sealants, and coating substances. The invention relates in particular to a two-component moisture-curing agent based on at least one silane-terminated polymer, to a method for the manufacture thereof, and to the use thereof.

Polymer systems that possess reactive silyl groups are known. In the presence of atmospheric moisture, polymers that possess silyl groups having hydrolyzable substituents are capable, even at room temperature, of condensing with one another with release of the hydrolyzed residues. Depending on the concentration of silyl groups having hydrolyzable substituents, and on the configuration of those silyl groups, what forms in this context are principally long-chain polymers (thermoplastics), relatively wide-mesh three-dimensional networks (elastomers), or highly crosslinked systems (thermosetting plastics).

The polymers generally comprise an organic backbone that carries at the ends, for example, alkoxy- or acyloxysilyl groups. The organic backbone can involve, for example, polyurethanes, polyesters, polyethers, etc. These kinds of α,ω-silane-substituted polymers are often notable for excellent flexibility and cohesion.

EP 0 931 800 A1, for example describes silylated polyurethanes that are obtained by reacting polyol components that have little terminal unsaturation with diisocyanates to yield hydroxy-terminated prepolymers, and subsequent capping with isocyanatosilanes. The polymers described are used to manufacture sealants.

A composition based on silyl-terminated polyoxyalkylene polymers is also described in EP 1 396 513 A1. The composition contains, in a first variant, both polymers having silyl terminal groups that have only one or two hydrolyzable groups, and polymers that have silyl terminal groups having three reactive groups. In a second variant, the two different types of silyl terminal groups are present simultaneously in one polyoxyalkylene polymer. According to EP 1 396 513 A1, such compositions are utilized in elastic, fast-curing adhesives and sealants.

The subject matter of WO 03/014226 A is one-component alkoxy-crosslinking materials that contain, besides low-molecular-weight specially substituted silanes, a polymer that contains terminal silyl groups, bound via a hydrocarbon residue to the polymer backbone, having one to three methoxy or ethoxy groups. The polymer can contain in particular terminal groups of the form —NR¹—CH₂—Si(R)ₐ(CH₃)₃₋ₐ (R=methoxy or ethoxy residue; R¹=hydrogen, alkyl or aryl residue; a=1 to 3), so-called α-silyl groups.

A curable composition that encompasses an organic polymer containing hydrolyzable silyl groups, and in addition a tin-based curing catalyst, is described in EP 1 304 354 A1.

For certain applications, in particular in the adhesive and sealant sector, it is necessary to minimize the time for immobilizing the substrates brought into contact with one another. Good adhesion of the substrates to one another nevertheless, of course, needs to be achieved. One such problem may be envisioned, for example, for industrial production lines in which, once certain parts have been adhesively bonded, the next processing step (in which mounted immobilization apparatuses might interfere) needs to occur as quickly as possible. Additionally of interest are adhesives and sealants that are as universally usable as possible, notable for good adhesion onto different substrates. It is often particularly challenging, but also particularly desirable, to achieve good adhesion when bonding plastics to one another.

The object of the present invention is thus to make available a curable agent that makes possible a rapid buildup of adhesion and stable, load-bearing adhesive bonds when joining plastics to one another. In addition, the agent is intended to be usable at room temperature, and to meet all general requirements placed on a modern adhesive and/or sealant. For example, the agent is intended to be easily applied and have good physiological compatibility.

The object is achieved by the subject matter of the present invention. The subject matter of the invention is a curable agent that contains two components (1) and (2) that are not in mutual contact, where component (1) contains at least one polymer having at least one terminal group of the general formula (I)

-Aₙ-CH₂—SiXYZ (I),

in which A is a divalent bonding group containing at least one heteroatom,
X, Y, Z are substituents on the Si atom and, mutually independently, are C₁ to C₈ alkyl, C₁ to C₈ alkoxy, or C₁ to C₈ acyloxy residues, where at least one of the substituents is a C₁ to C₈ alkoxy or C₁ to C₈ acyloxy residue, and
n is 0 or 1;
and component (2) contains at least water and at least one silanol condensation catalyst.

An agent of this kind exhibits a rapid buildup of cohesion and also makes possible, in particular, stable and strong bonding of plastics, such as e.g. polycarbonate or polypropylene, to one another. In addition, the adhesive bonds resp. sealing joins produced therewith sustainably exhibit very good adhesion values.

The term “curable” is to be understood to mean that under the influence of external conditions, in particular under the influence of moisture that is present in the environment and/or deliberately delivered, optionally is also already present in the agent, the agent is capable of transitioning from a plastically deformable state into a harder state. Curing can occur in general as a result of chemical and/or physical influences, i.e. besides the previously mentioned moisture also, for example, as a result of the delivery of energy in the form of heat, light, or other electromagnetic radiation, but also by simply bringing the composition into contact with air or with a reactive component.

Components (1) and (2) are not in contact with one another. This means that (1) and (2) are present separately from one another, for example in two different containers, and consequently, in particular, cannot enter into a chemical reaction with one another. Such a reaction is possible only after the components are brought together.

A “polymer” is understood as a substance that is constructed from a plurality of molecules in which one type or several types of atoms or atom groupings (so-called “constituent units,” “basic modules,” or “repeating units”) are repeatedly serially arranged. A “polymer molecule” for purposes of the present invention contains at least ten repeating units.

Component (1) contains at least one polymer having at least one terminal group of formula (I)

-Aₙ-CH₂—SiXYZ (I).

The polymer of component (1) is by preference a polyether or a poly(meth)acrylic acid ester, and particularly preferably a polyether. A “polyether” is understood as a polymer whose organic repeating units contain C—O—C ether functionalities in the main chain. Polymers having lateral ether groups, such as e.g. cellulose ethers, starch ethers, and vinyl ether polymers, are therefore not included among the polyethers. Polyacetals, such as polyoxymethylene (POM), are also not generally categorized as polyethers. A “poly(meth)acrylic acid ester” is understood as a polymer that is based on (meth)acrylic acid esters, which therefore comprises as a repeating unit the structural motif —CH₂CR^{a}(COOR^{b})— in which R^{b} denotes linear, branched, and/or cyclic alkyl residues and/or also ones containing functional substituents, for example methyl, ethyl, isopropyl, cyclohexyl, 2-ethylhexyl, or 2-hydroxyethyl residues, and in which R^{a} denotes either a hydrogen atom (polyacrylic acid ester) or a methyl group (polymethacrylic acid ester).

Polymers that contain polyethers as a basic skeleton have a flexible and elastic structure not only at the terminal groups but also in the polymer backbone. Agents that exhibit outstanding elastic properties can be manufactured therewith. Polyethers are not only flexible in their backbone, but also at the same time strong. For example, they are not attacked or decomposed by water and bacteria. In the context of the present invention, it is particularly preferable to use polyethers based on polyethylene oxide and/or polypropylene oxide, very particularly preferably on polypropylene oxide, in component (1).

Component (1) preferably contains at least one alkoxyl- and/or acyloxysilane-terminated polyether that has a molecular weight Mₙ from 4000 to 100,000, by preference from 8,000 to 50,000, particularly preferably from 10,000 to 30,000, in particular from 15,000 to 25,000 g/mol. The “molecular weight Mₐ” is understood as the number-average molecular weight of the polymer. For purposes of the present invention the number-average molecular weight Mₙ as well as the weight-average molecular M_{w} are determined by gel permeation chromatography (GPC) using polystyrene as a standard. Such a method is known to one skilled in the art. The molecular weights indicated are particularly advantageous because the corresponding agents exhibit a balanced relationship between viscosity (easy processability), strength, and elasticity. This combination is very advantageously expressed in a consequently preferred molecular weight range (Mₙ) from 12,000 to 30,000, more preferably from 14,000 to 27,000, and in particular from 16,000 to 24,000 g/mol.

At least one polyether in which the ratio M_{w}/Mₙ is less than 1.5 is preferably contained in component (1) in the context of the present invention. The ratio M_{w}/Mₙ (also referred to as “polydispersity”) indicates the breadth of the molar mass distribution and thus the differing degrees of polymerization of the individual chains in polydisperse polymers. For many polymerizates and polycondensates, the applicable polydispersity value is approximately 2. Strict monodispersity would exist for a value of 1. The polydispersity of less than 1.5 that is preferred in the context of the present invention indicates a comparatively narrow molecular weight distribution and thus the specific expression of properties associated with molecular weight, for example viscosity. Particularly preferably, at least one alkoxy- and/or acyloxysilane-terminated polyether of component (1) has a polydispersity (M_{w}/Mₙ) of less than 1.3.

The polyether(s) preferably used in component (1) is/are also preferably notable for a low number of double bonds at the ends of the polymer chain. This so-called “terminal unsaturation” results from an undesired side reaction in the context of polymerization of low-molecular-weight diols with alkylene oxides. The result is that a certain proportion of monohydroxypolyethers are present, which can be silylated only at a chain end and correspondingly can also only crosslink via a chain end. This has disadvantageous effects on the functionality of the polyethers and of the compositions manufactured therefrom. Polyethers having a small number of terminal double bonds can be manufactured, for example, by double metal cyanide (DMC) catalysis. Component (1) preferably contains at least one polyether that has a terminal unsaturation of less than 0.07 meq/g, determined using the ASTM D4671 method.

The polymer(s) of component (1) comprise(s) at least one terminal group of formula (I)

-Aₙ-CH₂—SiXYZ (I),

in which
A is a divalent bonding group containing at least one heteroatom,
X, Y, Z are substituents on the Si atom and, mutually independently, are C₁ to C₈ alkyl,
C₁ to C₈ alkoxy, or C₁ to C₈ acyloxy groups, where at least one of the substituents is a C₁ to C₈ alkoxy or C₁ to C₈ acyloxy group, and
n is 0 or 1.

A “divalent” (or “double-bond”) bonding group A is understood as a chemical group that links the polymer backbone of the alkoxy- and/or acyloxysilane-terminated polymer to the methylene residue of the terminal group. The divalent bonding group A can be formed, for example, in the context of manufacture of an alkoxy- and/or acyloxysilane-terminated polyether polymer or poly(meth)acrylic acid ester polymer, for example as a carbamate group, by reaction between a polyether, functionalized with hydroxy groups, and an isocyanatosilane. The divalent bonding group can be both distinguishable and indistinguishable from structural features occurring in the basic polymer skeleton. The latter situation exists, for example, when it is identical to the linking points of the repeating units of the polymer skeleton.

A is preferably an amide, carbamate resp. urethane, urea, imino, carboxylate, carbamoyl, amidino, carbonate, sulfonate, or sulfinate group, or an oxygen or nitrogen atom. The divalent bonding group A in formula (I) is particularly preferably a carbamate group or urea group. These groups can be obtained by reacting specific functional groups of a prepolymer with an organosilane that carries a further functional group.

A “carbamate group” or “urethane group” is understood as a structural motif of the formula —NH—C(O)—O—. Carbamate groups can be produced, for example, either when the polymer skeleton contains terminal hydroxy groups and when isocyanatosilanes are used as a further component, or when, conversely, a polymer that comprises terminal isocyanate groups is reacted with an alkoxysilane containing terminal hydroxy groups. Urethane groups can be obtained in similar fashion when a terminal primary or secondary amino group (on either the silane or the polymer), which reacts with a terminal isocyanate group present in the respective reaction partner, is used. This means that a reaction is brought about either between an aminosilane and a polymer comprising terminal isocyanate groups, or between an isocyanatosilane and a polymer terminally substituted with an amino group. A “urea group” is correspondingly understood as a structural motif of the formula —NH—C(O)—NR^{c}—, where R^{c} denotes a hydrogen atom or any substituted or unsubstituted hydrocarbon residue.

Carbamate and urea groups advantageously increase the strength of the polymer chains and of the entire crosslinked polymer.

The variable “n” can assume a value of 0 or 1, i.e. the divalent bonding group A links the basic polymer skeleton to the methylene group (n=1), or the polymer backbone is bonded resp. linked directly to the methylene group (n=0).

It has been found that the methylene group that links the polymer skeleton (optionally via bonding group A) to the silyl group is of essential importance for the reactivity, particularly high according to the present invention, of the terminating silyl group, and thus for the shortened setting times and very fast curing of the formulations.

X, Y, and Z are, mutually independently, C₁ to C₈ alkyl residues, C₁ to C₈ alkoxy residues, or C₁ to C₈ acyloxy residues. At least one of the substituents X, Y, Z must be a hydrolyzable group, i.e. a C₁ to C₈ alkoxy residue or a C₁ to C₈ acyloxy residue. Alkoxy groups, in particular methoxy, ethoxy, n-propyloxy, isopropyloxy, and butyloxy groups, are by preference selected as hydrolyzable groups. This is advantageous because agents containing such alkoxy groups do not, upon curing, release any substances that irritate the mucous membranes. The alcohols that are formed are harmless in the quantities released, and evaporate. Such agents are therefore particularly suitable for the homeowner sector. Acyloxy groups can also be used as hydrolyzable groups, however, for example an acetoxy group —O—CO—CH₃.

Preferably one of the substituents resp. residues X, Y, Z in formula (I) is a C₁ to C₈ alkyl group and the other two substituents are mutually independently C₁ to C₈ alkoxy groups; or all the substituents X, Y, and Z are, mutually independently, C₁ to C₈ alkoxy groups. In general, polymers that contain di-resp. trialkoxysilyl groups possess highly reactive linking sites that enable rapid curing, high degrees of crosslinking, and thus good final strength values. The particular advantage of dialkoxysilyl groups is that the corresponding compositions are, after curing, more elastic, softer, and more flexible than systems containing trialkoxysilyl groups. They furthermore release even less alcohol upon curing, and are therefore of particular interest when the quantity of alcohol released needs to be reduced.

With trialkoxysilyl groups on the other hand, a higher degree of crosslinking can be achieved, which is particularly advantageous if a harder, more solid substance is desired after curing. Trialkoxysilyl groups are moreover more reactive, i.e. crosslink more quickly, and thus decrease the quantity of catalyst required; and they have advantages in terms of “cold flow,” i.e. the dimensional stability of a corresponding adhesive under the influence of force and, if applicable, temperature.

Particularly preferably, the substituents X, Y, and Z in formula (I) are, mutually independently in each case, a methyl residue, an ethyl residue, a methoxy residue, or an ethoxy residue. Methoxy and ethoxy residues, being comparatively small hydrolyzable groups having a low steric demand, are highly reactive and thus enable rapid curing even when little catalyst is used, and thus enable rapid adhesion buildup as well as high initial adhesion.

Particularly preferably, X, Y, and Z, mutually independently in each case, are a methyl residue or a methoxy residue. Compounds having alkoxysilyl groups have different levels of reactivity in chemical reactions depending on the nature of the alkyl residues on the oxygen atom. Among the alkoxy groups, the methoxy group exhibits the greatest reactivity. Silyl groups of this kind can thus be resorted to when particularly rapid curing is desired. Higher aliphatic residues, such as ethoxy, already produce a lower reactivity in the terminal alkoxysilyl group as compared with methoxy groups, and can be used advantageously to implement graduated crosslinking rates.

Interesting configuration capabilities are also offered by combinations of the two groups. If methoxy is selected for X and ethoxy for Y within the same alkoxysilyl group, for example, the desired reactivity of the terminating silyl groups can be adjusted with particular precision if silyl groups carrying exclusively methoxy groups are felt to be too reactive, and the silyl groups carrying ethoxy groups too sluggish, for the intended purpose.

In addition to methoxy and ethoxy groups, larger residues (which, naturally have lower reactivity) can of course also be used as hydrolyzable groups. This is of interest in particular when delayed curing is also intended to be achieved by way of the configuration of the alkoxy groups.

The —SiXYZ group of formula (1) is particularly preferably a methyldimethoxysilyl group. Silyl groups of this kind have proven to be particularly suitable for obtaining stable bonds between plastics. They are moreover also advantageous in terms of rapid adhesion buildup in the agents according to the present invention.

The alkoxy- and/or acyloxysilane-terminated polymer(s) of component (1) preferably comprise(s) at least two terminal groups of formula (I). Each polymer chain thus contains at least two linking sites at which condensation of the polymers can take place in the presence of atmospheric moisture, with release of the hydrolyzed residues. Well-controlled and rapid crosslinking capability can thereby be achieved, so that adhesive bonds with good strength values can be obtained. In addition, the configuration of the achievable network as a long-chain system (thermoplastics), relatively wide-mesh three-dimensional network (elastomers), or highly crosslinked system (thermosetting plastics) can be controlled by way of the quantity and structure of the hydrolyzable groups (e.g. by the use of di- or trialkoxysilyl groups, methoxy groups, or longer residues, etc.), so that the elasticity, flexibility, and high-temperature strength, among other characteristics, of the completely crosslinked compositions can thereby be influenced. It is further preferred that the alkoxy- and/or acyloxysilane-terminated polymers of component (1) comprise on average more than one terminal group of formula (I), by preference 1.1 to 5 terminal groups of formula (I).

Particularly preferably, the polymer of component (1) comprises at least one terminal group of the formulas —O—CO—NH—CH₂—Si(OMe)₂Me or —N(R¹)—CO—NH—CH₂—Si(OMe)₂Me, in which R¹ denotes a hydrogen atom or an alkyl group having 1 to 8 carbon atoms. Terminal groups of this kind have proven to be particularly suitable for enabling rapid adhesion buildup and high adhesive strength, in particular when bonding plastics to one another.

The total content in component (1) of polymer(s) having at least one terminal group of formula (I) is preferably 5 to 45 wt %, more preferably 10 to 40 wt %, in particular 15 to 35 wt %, and very particularly preferably 20 to 30 wt %, based in each case on the total weight of component (1). Polymers having at least one terminal group of formula (I) are preferably contained in the agent according to the present invention only in component (1).

Component (2) of the curable agent according to the present invention contains at least water and at least one silanol condensation catalyst. A “silanol condensation catalyst” is understood as a compound that can catalyze the formation of a Si—O—Si bond, with release of a water molecule, from two Si—OH groups. The silanol condensation catalyst is preferably an organotin compound, a mono- or polyamine, and/or a heterocyclic amine. The silanol condensation catalyst of the present invention is particularly preferably an organotin compound.

Suitable tin organyls are, for example, 1,3-dicarbonyl compounds of divalent resp. tetravalent tin, for example acetylacetonates such as di(n-butyl)tin(IV) di(acetylacetonate), di(n-octyl)tin(IV) di(acetylacetonate), (n-octyl)(n-butyl)tin(IV) di(acetylacetonate); dialkyltin(IV) dicarboxylates, for example di-n-butyltin dilaurate, di-n-butyltin maleate, di-n-butyltin diacetate, di-n-octyltin diacetate, or the corresponding dialkoxylates, for example di-n-butyltin dimethoxide; as well as the tin(II) carboxylates such as tin(II) octoate or tin(II) phenolate.

The following compounds of tin are also suitable: ethyl silicate, dimethyl maleate, diethyl maleate, dioctyl maleate, dimethyl phthalate, diethyl phthalate, dioctyl phthalate, di(n-butyl)tin(IV) di(methyl maleate), di(n-butyl)tin(IV) di(butyl maleate), di(n-octyl)tin(IV) di(methyl maleate), di(n-octyl)tin(IV) di(butyl maleate), di(n-octyl)tin(IV) di(isooctyl maleate), di(n-butyl)tin(IV) sulfide, di(n-butyl)tin(IV) oxide, di(n-octyl)tin(IV) oxide, (n-butyl)₂Sn(SCH₂COO), (n-octyl)₂Sn(SCH₂COO), (n-octyl)₂Sn(SCH₂CH₂COO), (n-octyl)₂Sn(SCH₂CH₂COOCH₂CH₂OCOCH₂S), (n-butyl)₂Sn(SCH₂COO-i-C₈H₁₇)₂, (n-octyl)₂Sn(SCH₂COO-i-C₈H₁₇)₂, (n-octyl)₂Sn(SCH₂COO-n-C₈H₁₇)₂. The silanol condensation catalyst is particularly preferably a dialkyltin(IV) dicarboxylate, in particular di-n-butyltin dilaurate.

Suitable mono- or polyamines are, for example, aliphatic monoamines such as butylamine, hexylamine, octylamine, decylamine, or laurylamine; aliphatic diamines such as ethylenediamine or hexanediamine; aliphatic polyamines such as diethylenetriamine, triethylenetetramine, or tetraethylenepentamine; aromatic amines such as m-phenylenediamine; also ethanolamine, triethylamine, and modified amines such as those also known as curing catalysts for epoxy resins.

Examples of usable heterocyclic amines are N-methylpyrrolidine, N-methylpiperidine, N,N-dimethylpiperazine, diazabicyclooctane (DABCO), N-(2-hydroxyethoxyethyl)-2-azanorbornane, 1,8-diazabicyclo(5.4.0)undec-7-ene (DBU), N-dodecyl-2-methylimidazole, N-methylimidazole, 2-ethyl-2-methylimidazole, N-methylmorpholine, bis(2-(2,6-dimethyl-4-morpholino)ethyl)-(2-(4-morpholino)ethyl)amine, bis(2-(2,6-dimethyl-4-morpholino)ethyl)-(2-(2,6-diethyl-4-morpholino)ethyl)amine, tris(2-(4-morpholino)ethyl)amine, tris(2-(4-morpholino)propyl)amine, tris(2-(4-morpholino)butyl)amine, tris(2-(2,6-dimethyl-4-morpholino)ethyl)amine, tris(2-(2,6-diethyl-4-morpholino)ethyl)amine, tris(2-(2-methyl-4-morpholino)ethyl)amine, tris(2-(2-ethyl-4-morpholino)ethyl)amine, dimethylaminopropylmorpholine, bis-(morpholinopropyl)methylamine, diethylaminopropylmorpholine, bis(morpholinopropyl)ethylamine, bis(morpholinopropyl)propylamine, morpholinopropylpyrrolidone, N-morpholinopropyl-N′-methylpiperazine, dimorpholinodiethyl ether (DMDEE), or di-2,6-dimethylmorpholinoethyl)ether, as well as substituted guanidines. 1,8-diazabicyclo(5.4.0)undec-7-ene (DBU) is particularly preferred.

The silane condensation catalyst is present preferably in a quantity from 0.01 to 3 wt %, more preferably from 0.05 to 2 wt %, in particular from 0.1 to 1.5 wt %, and very particularly preferably from 0.3 to 1 wt %, based in each case on the total weight of component (2) of the agent according to the present invention. Mixtures of several catalysts can also be used. Preferably only component (2) of the curable agent according to the present invention contains one or more silane condensation catalyst(s).

Water is present preferably in a quantity from 0.1 to 15 wt %, more preferably from 1 to 12 wt %, in particular from 2 to 10 wt %, and very particularly preferably from 4 to 8 wt %, based in each case on the total weight of component (2). Preferably only component (2) of the curable agent according to the present invention contains water.

Components (1) and (2) of the agent according to the present invention can also contain, in addition to those already described, further ingredients that impart to them improved elastic properties, improved elastic recovery, and low residual tack. Included among these adjuvants and additives are, for example, adhesion promoters, plasticizers, and fillers. The agents can moreover contain as further additives, for example, stabilizers, antioxidants, reactive diluents, drying agents, UV stabilizers, aging protection agents, rheological adjuvants, color pigments or color pastes, fungicides, flame retardants, and/or optionally also, to a small extent, solvents.

A “plasticizer” is understood as a substance that decreases the viscosity of the agent and thus facilitates the processability, and moreover improves the flexibility and extension capability, of the agent.

In the context of the present invention the plasticizer is preferably selected from a fatty acid ester, a dicarboxylic acid ester, an ester of OH-group-carrying or epoxidized fatty acids, a fat, a glycolic acid ester, a phthalic acid ester, a benzoic acid ester, a phosphoric acid ester, a sulfonic acid ester, a trimellitic acid ester, an epoxidized plasticizer, a polyether plasticizer, a polystyrene, a hydrocarbon plasticizer, and a chlorinated paraffin, as well as mixtures of two or more thereof. Targeted selection of one of these plasticizers, or of a specific combination, allows further advantageous properties of the agent according to the present invention, e.g. the gelling capability of the polymers, low-temperature elasticity resp. low-temperature strength, or even antistatic properties, to be implemented.

Suitable from the group of the phthalic acid esters, for example, are dioctyl phthalate, dibutyl phthalate, diisodecyl phthalate, diisoundecyl phthalate, diisononyl phthalate, or butylbenzyl phthalate; of the adipates, dioctyl adipate, diisodecyl adipate, also diisodecyl succinate, dibutyl sebacate, or butyl oleate. Of the polyether plasticizers, it is preferred to use end-capped polyethylene glycols, for example polyethylene or polypropylene glycol di-C₁₋₄ alkyl ethers, in particular the dimethyl or diethyl ethers of diethylene glycol or of dipropylene glycol, as well as mixtures of two or more thereof. Also suitable as plasticizers are, for example, esters of abietic acid, butyric acid esters, acetic acid esters, propionic acid esters, thiobutyric acid esters, citric acid esters, and esters based on nitrocellulose and polyvinyl acetate, as well as mixtures of two or more thereof. Also suitable are, for example, the asymmetrical esters of adipic acid monooctyl ester with 2-ethylhexanol (Edenol DOA, Cognis Deutschland GmbH, Dusseldorf). The pure or mixed ethers of monofunctional, linear or branched C₄₋₁₆ alcohols, or mixtures of two or more different ethers of such alcohols, for example dioctyl ethers (obtainable as Cetiol OE, Cognis Deutschland GmbH, Düsseldorf), are also suitable as plasticizers. Likewise suitable in the context of the present invention as plasticizers are diurethanes, which can be manufactured e.g. by reacting diols having OH terminal groups with monofunctional isocyanates, by selecting the stoichiometry so that substantially all the free OH groups react completely. Any excess isocyanate can then be removed from the reaction mixture, for example, by distillation. A further method for manufacturing diurethanes involves reacting monofunctional alcohols with diisocyanates, such that all the NCO groups react as completely as possible.

In the context of the present invention, plasticizer is contained preferably in both components of the agent. Plasticizer(s) is/are contained in component (1) in a quantity preferably from 1 to 40 wt %, particularly preferably from 5 to 35 wt %, in particular from 10 to 30 wt %, and very particularly preferably from 15 to 30 wt %, based in each case on the total weight of component (1). Plasticizer(s) is/are contained in component (2) in a quantity preferably from 20 to 95 wt %, particularly preferably from 30 to 85 wt %, in particular from 40 to 80 wt %, and very particularly from 50 to 70 wt %, based in each case on the total weight of component (2).

A viscosity of the agent according to the present invention that is too high for specific applications can also be decreased in simple and useful fashion by using a reactive diluent, without resulting in demixing phenomena (e.g. plasticizer migration) in the cured substance. The reactive diluent preferably comprises at least one functional group that reacts after application, for example, with moisture or with atmospheric oxygen. Examples of such groups are silyl groups, isocyanate groups, vinyl-unsaturated groups, and polyunsaturated systems. All compounds that are miscible with the agent according to the present invention accompanied by a decrease in viscosity, and that possess at least one group reactive with the binding agent, are suitable, alone or as a combination of multiple compounds, as reactive diluents. The viscosity of the reactive diluent is preferably less than 20,000 mPas, particularly preferably approximately 0.1 to 6000 mPas, very particularly preferably 1 to 1000 mPas (Brookfield RVT, 23° C., spindle 7, 10 rpm).

The following substances can be used, for example, as reactive diluents: polyalkylene glycols reacted with isocyanatosilanes (e.g. Synalox 100-50B, Dow), alkyltrimethoxysilane, alkyltriethoxysilane, such as methyltrimethoxysilane, methyltriethoxysilane, and vinyltrimethoxysilane (XL 10, Wacker), phenyltrimethoxysilane, phenyltriethoxysilane, octyltrimethoxysilane, tetraethoxysilane, vinyldimethoxymethylsilane (XL12, Wacker), vinyltriethoxysilane (GF56, Wacker), vinyltriacetoxysilane (GF62, Wacker), isooctyltrimethoxysilane (10 Trimethoxy), isooctyltriethoxysilane (10 Triethoxy, Wacker), N-trimethoxysilylmethyl-O-methyl carbamate (XL63, Wacker), N-dimethoxy(methyl)silylmethyl-O-methyl carbamate (XL65, Wacker), hexadecyltrimethoxysilane, 3-octanoylthio-1-propyltriethoxysilane, and partial hydrolysates of these compounds. Also usable as reactive diluents are the following polymers of Kaneka Corp.: MS S203H, MS 5303H, MS SAT 010, and MS SAX 350. Also suitable as reactive diluents are polymers that can be manufactured from an organic skeleton by grafting with a vinylsilane or by reacting with polyol, polyisocyanate, and alkoxysilane.

A “polyol” is understood as a compound that can contain multiple OH groups in the molecule. The OH groups can be both primary and secondary. Included among the suitable aliphatic alcohols are, for example, ethylene glycol, propylene glycol, and higher glycols, as well as other polyfunctional alcohols. The polyols can additionally contain further functional groups such as, for example, esters, carbonates, amides. For manufacture of a reactive diluent by reacting polyol with polyisocyanate and alkoxysilane, the corresponding polyol component is reacted respectively with an at least difunctional isocyanate. Any isocyanate having at least two isocyanate groups is appropriate in principle as an at least difunctional isocyanate, but compounds having two to four isocyanate groups, in particular having two isocyanate groups, are preferred as a rule in the context of the present invention. The di- and trialkoxysilyl groups are preferred among the alkoxysilyl groups.

Suitable polyisocyanates for manufacturing a reactive diluent are, for example, ethylene diisocyanate, 1,4-tetramethylene diisocyanate, 1,4-tetramethoxybutane diisocyanate, 1,6-hexamethylene diisocyanate (HDI), cyclobutane 1,3-diisocyanate, cyclohexane 1,3- and 1,4-diisocyanate, bis(2-isocyanatoethyl)fumarate, as well as mixtures of two or more thereof, 1-isocyanato-3,3,5-trimethyl-5-isocyanatomethylcyclohexane (isophorone diisocyanate, IPDI), 2,4- and 2,6-hexahydrotoluoylene diisocyanate, hexahydro-1,3- or -1,4-phenylene diisocyanate, benzidine diisocyanate, naphthalene 1,5-diisocyanate, 1,6-diisocyanato-2,2,4-trimethylhexane, 1,6-diisocyanato-2,4,4-trimethylhexane, xylylene diisocyanate (XDI), tetramethylxylylene diisocyanate (TMXDI), 1,3- and 1,4-phenylene diisocyanate, 2,4- or 2,6-toluoylene diisocyanate (TDI), 2,4′-diphenylmethane diisocyanate, 2,2′-diphenylmethane diisocyanate, or 4,4′-diphenylmethane diisocyanate (MDI), or partially or completely hydrogenated cycloalkyl derivatives thereof, for example completely hydrogenated MDI (H12-MDI), alkyl-substituted diphenylmethane diisocyanates, for example mono-, di-, tri-, or tetraalkyldiphenylmethane diisocyanate as well as partially or completely hydrogenated cycloalkyl derivatives thereof, 4,4′-diisocyanatophenylperfluorethane, phthalic acid bisisocyanatoethyl ester, 1-chloromethylphenyl-2,4- or -2,6-diisocyanate, 1-bromomethylphenyl-2,4- or -2,6-diisocyanate, 3,3-bischloromethyl ether-4,4′-diphenyldiisocyanate, sulfur-containing diisocyanates such as those obtainable by reacting 2 mol diisocyanate with 1 mol thiodiglycol or dihydroxyhexylsulfide, di- and triisocyanates of di- and trimer fatty acids, or mixtures of two or more of the aforesaid diisocyanates.

It is also possible to use as polyisocyanates trivalent or higher-valence isocyanates such as those obtainable, for example, by oligomerization of diisocyanates, in particular by oligomerization of the aforementioned isocyanates. Examples of such trivalent and higher-valence polyisocyanates are the triisocyanurates of HDI or IPDI or mixtures thereof, or mixed triisocyanurates thereof, as well as polyphenylmethylene polyisocyanate as obtainable by phosgenation of aniline-formaldehyde condensation products.

Solvents can also be used, alongside or instead of a reactive diluent, to reduce the viscosity of the agent according to the present invention. Aliphatic or aromatic hydrocarbons, halogenated hydrocarbons, alcohols, ketones, ethers, esters, ester alcohols, keto alcohols, keto ethers, keto esters, and ether esters are suitable as solvents. Alcohols are, however, used by preference, since shelf stability then rises. C₁ to C₁₀ alcohols, in particular methanol, ethanol, isopropanol, isoamyl alcohol, and hexanol, are particularly preferred.

The agent according to the present invention can furthermore encompass an adhesion promoter. An “adhesion promoter” is understood as a substance that improves the adhesion properties of adhesive layers onto surfaces. Usual adhesion promoters (tackifiers) known to one skilled in the art can be used, alone or as a combination of multiple compounds. Resins, terpene oligomers, coumaron/indene resins, aliphatic petrochemical resins, and modified phenol resins are, for example, suitable. Suitable in the context of the present invention are, for example, hydrocarbon resins such as those obtained by the polymerization of terpenes, chiefly α- or β-pinenes, dipentenes, or limonenes. Polymerization of these monomers is generally performed cationically, with initiation using Friedel-Crafts catalysts. Also included among the terpene resins, for example, are copolymers of terpenes and of other monomers, for example styrene, α-methylstyrene, isoprene, and the like. The aforesaid resins are utilized, for example, as adhesion promoters for contact adhesives and coating materials. Also suitable are the terpene-phenol resins that are produced by acid-catalyzed addition of phenols to terpenes or colophon. Terpene-phenol resins are soluble in most organic solvents and oils and are miscible with other resins, waxes, and rubber. Also suitable in the context of the present invention as adhesion promoters in the aforementioned sense are the colophon resins and derivatives thereof, for example esters or alcohols thereof. Silane adhesion promoters, in particular aminosilanes, are particularly well suited.

In a special embodiment of the curable agent according to the present invention, the agent encompasses as an adhesion promoter a silane of formula (II)

R′R″—N—R′″—SiXYZ (II),

in which
R′ and R″ are, mutually independently, hydrogen or C₁ to C₈ alkyl residues,
R′″ is a divalent hydrocarbon residue having 1 to 12 carbon atoms and optionally containing a heteroatom, and
X, Y, Z are, mutually independently in each case, C₁ to C₈ alkyl, C₁ to C₈ alkoxy, or C₁ to C₈ acyloxy residues, where at least one of the substituents X, Y, Z is a C₁ to C₈ alkoxy group or C₁ to C₈ acyloxy group.

Such compounds of course have a high affinity for the bonding polymer components of the curable agent according to the present invention, but also for a wide spectrum of polar as well as nonpolar surfaces, and therefore contribute to the formation of particularly stable adhesion between the adhesive composition and the respective substrates to be bonded.

The bonding group R′″ can be, for example, a straight-chain or branched or cyclic, substituted or unsubstituted alkylene residue. Nitrogen (N) or oxygen (O) is optionally contained therein as a heteroatom. If X, Y, and/or Z is an acyloxy group, it can be, for example, the acetoxy group —OCO—CH₃.

An adhesion promoter is, in the context of the present invention, contained preferably in component (1).

Fillers suitable for the agent according to the present invention are, for example, chalk, lime powder, precipitated and/or pyrogenic silicic acid, zeolites, bentonites, magnesium carbonate, diatomite, alumina, clay, talc, titanium oxide, iron oxide, zinc oxide, sand, quartz, flint, mica, glass powder, and other ground mineral substances. Organic fillers can also be used, in particular carbon black, graphite, wood fibers, wood flour, sawdust, cellulose, cotton, pulp, wood chips, chopped straw, chaff, ground walnut shells, and other chopped fibers. Short fibers such as glass fibers, glass filament, polyacrylonitrile, carbon fibers, Kevlar fibers, or also polyethylene fibers can also be added. Aluminum powder is likewise suitable as a filler. Also suitable as fillers are hollow spheres having a mineral shell or a plastic shell. These can be, for example, hollow glass spheres that are obtainable commercially under the trade names Glass Bubbles®. Plastic-based hollow spheres, for example Expancel® or Dualite®, are made up of inorganic or organic substances and each have a diameter of 1 mm or less, preferably 500 μm or less. Fillers that impart thixotropy to the preparations are preferred for many applications. Such fillers are also described as rheological adjuvants, e.g. hydrogenated castor oil, fatty acid amides, or swellable plastics such as PVC.

By preference, both components of the curable agent according to the present invention contain a filler or a combination of several fillers. Filler(s) is/are contained in component (1) in a quantity preferably from 20 to 80 wt %, particularly preferably from 30 to 70 wt %, in particular from 40 to 60 wt %, and very particularly preferably from 43 to 55 wt %, based in each case on the total weight of component (1). Component (2) contains preferably 10 to 50 wt %, particularly preferably 15 to 45 wt %, in particular 20 to 40 wt %, and very particularly preferably 25 to 35 wt % filler(s), based in each case on the total weight of component (2).

A highly dispersed silicic acid having a BET surface area from 10 to 500 m²/g is used, for example, as a filler. When a silicic acid of this kind is used, it produces no substantial increase in the viscosity of the agent according to the present invention but does contribute to reinforcing the cured preparation. This reinforcement improves, for example, the initial strength values, tensile shear strength, and adhesion of the adhesives, sealants, or coating materials in which the composition according to the present invention is used. Uncoated silicic acids having a BET surface area of preferably less than 100, with greater preference less than 65 m²/g, and/or coated silicic acids having a BET surface area from 100 to 400, with greater preference from 100 to 300, in particular from 150 to 300, and very particularly preferably from 200 to 300 m²/g are used.

A zeolite or a mixture of different zeolites can also be used as a filler. Alkali aluminosilicates are preferred for use as a zeolite, for example sodium-potassium aluminosilicates of the general empirical formula aK₂O*bNa₂O*Al₂O₃*2SiO*nH₂O, where 0<a, b<1, and a+b=1. The pore opening of the zeolite(s) used is preferably just large enough to accept water molecules. An effective pore opening of the zeolites of less than 0.4 nm is accordingly preferred. Particularly preferably, the effective pore opening is 0.3 nm+/−0.02 nm. Such (a) zeolite(s) is/are used preferably in the form of a powder.

Particularly preferably, the agent according to the present invention contains one or more chalk(s) as a filler. Cubic, non-cubic, amorphous, and other modifications of calcium carbonate can be used as chalk. The chalk(s), or at least one of the chalk(s), used is/are preferably surface-treated resp. coated. Fatty acids, fatty acid soaps, and fatty acid esters are preferably used as coating agents, for example lauric acid, palmitic acid, or stearic acid, sodium salts or potassium salts of such acids, or alkyl esters thereof. Also appropriate in addition, however, are other surface-active substances such as sulfate esters of long-chain alcohols or alkylbenzenesulfonic acids resp. sodium salts or potassium salts thereof, or also coupling reagents based on silanes or titanates. The surface treatment of the chalks is often associated with an improvement in processability and adhesive strength, and also in the weather resistance of the compositions. The coating agent is used usually at a proportion from 0.1 to 20 wt %, preferably 1 to 5 wt %, based on the total weight of the raw chalk. A mixture of surface-treated and non-surface-treated chalk is used particularly preferably as a filler in the agent according to the present invention.

Precipitated or ground chalks can be used depending on the desired properties profile. Ground chalks can be manufactured, for example, from natural lime, limestone, or marble by mechanical grinding; dry or wet methods can be utilized. Fractions having different average particle sizes are obtained depending on the grinding method. Advantageous specific surface area values (BET) are between 1.5 m²/g and 50 m²/g.

The agent according to the present invention can furthermore contain antioxidants, which are particularly preferably present in component (1). The proportion of antioxidants in component (1) is by preference up to 4 wt %, in particular up to 1 wt %, based on the total weight of component (1). The agent according to the present invention can moreover contain UV stabilizers, which are preferably present in component (1). The proportion of UV stabilizers in component (1) is by preference up to approximately 1 wt %, in particular up to approximately 0.2 wt %. The so-called hindered amine light stabilizers (HALS) are particularly suitable as UV stabilizers. It is preferred in the context of the present invention if a UV stabilizer that carries a silyl group, and that is incorporated into the end product upon crosslinking resp. curing, is used. The products Lowilite 75, Lowilite 77 (Great Lakes company, USA) are particularly suitable for this purpose. Benzotriazoles, benzophenones, benzoates, cyanoacrylates, acrylates, sterically hindered phenols, phosphorus, and/or sulfur can also be added.

It is often useful to further stabilize component (1) of the agent according to the present invention with regard to penetrating moisture, in order to enhance shelf life even further. Such improvement in shelf life can be achieved, for example, with the use of drying agents. Suitable as drying agents are all compounds that react with water to form a group that is inert with respect to the reactive groups present in the composition, and in that context experience as little change as possible in their molecular weight. In addition, the reactivity of the drying agent with respect to moisture that has penetrated into the composition must be greater than the reactivity of the terminal groups of the silyl-group-carrying polymers according to the present invention that are present in the composition. Isocyanates, for example, are suitable as drying agents.

Advantageously, silanes are also used as a drying agent, for example vinylsilanes such as 3-vinylpropyltriethoxysilane, oximosilanes such as methyl-O,O′,O″-butan-2-onetrioximosilane or O,O¹,O″,O′″-butan-2-onetetraoximosilane (CAS nos. 022984-54-9 and 034206-40-1) or benzamidosilanes such as bis(N-methylbenzamido)methylethoxysilane (CAS no. 16230-35-6) or carbamatosilanes such as carbamatomethyltrimethoxysilane. The use of methyl-, ethyl- or vinyltrimethoxysilane, tetramethyl- or -ethylethoxysilane is, however, also possible. Vinyltrimethoxysilane and tetraethoxysilane are particularly preferred here in terms of efficiency and cost. The reactive diluents recited above are likewise suitable as drying agents, provided they have a molecular weight (Mₙ) of less than approximately 5000 g/mol and possess terminal groups whose reactivity with respect to moisture that has penetrated is at least as great as, preferably greater than, the reactivity of the reactive groups of the silyl-group-carrying polymer according to the present invention. Lastly, alkyl orthoformates or alkyl orthoacetates can also be used as drying agents, for example methyl or ethyl orthoformate, methyl or ethyl orthoacetate. The agent according to the present invention contains, preferably in component (1), by preference approximately 0.01 to 5 wt %, particularly preferably 0.1 to 2 wt % drying agent, based on the total weight of component (1).

The agent according to the present invention preferably contains in component (1)

a) 10 to 40 wt % polymer having at least one terminal group of formula (I),

b) 30 to 70 wt % filler,

c) 5 to 30 wt % plasticizers,

d) 0 to 10 wt % adjuvants,

and in component (2)

e) 0 to 50 wt % filler,

f) 30 to 95 wt % plasticizer or reactive diluent,

g) 1 to 10 wt % water,

h) 0.05 to 2 wt % silanol condensation catalyst,

i) 0 to 5 wt % further adjuvants,

the “wt %” indications being based in each case on the total weight of the corresponding component, and the proportions of the ingredients in the two components adding up in each case to 100 wt %. This means that, for example, the 30 to 70 wt % filler in component (1) is based on the total weight of component (1), and further that, for example, addition of the proportions by weight of the ingredients of component (1) yields 100 wt %.

Formulation of the agents according to the present invention as a multi-component system is essential for successful utilization. A one-component formulation that contains the constituents listed above (with the exception of water) did not exhibit satisfactory curing.

Provision is made according to the present invention to mix components (1) and (2) of the curable agent prior to utilization, the weight ratio of component (1) to component (2) being by preference from 2:1 to 8:1, particularly preferably from 3:1 to 7:1, in particular from 4:1 to 6:1.

A further subject of the present invention is the use of the curable agent according to the present invention as an adhesive and/or sealant. The fact that the agent according to the present invention enables fast bonding with good adhesion has already been described herein.

It is particularly preferred to use the agent according to the present invention as an adhesive for bonding plastics, in particular synthetic thermoplastics, for example polycarbonate and polypropylene or also polyacrylate. In particular, it is possible to obtain stable bonding of such plastic substrates even when at least one of the substrates is transparent. The transparent substrate is, for example, polycarbonate or polyacrylate. A very particularly preferred use of the agent according to the present invention is use as an adhesive for bonding headlights in vehicles, in which context a transparent component is bonded into a mount provided for it.

### EXAMPLES

### Producing the Test Articles for the Tensile Shear Test

Immediately before the test articles are produced, the two-component adhesive/sealant is made ready for use by intensively mixing the two components (60 seconds).

Three test articles are needed for each measurement. Substrate elements having a total length of 7.3 cm, having at one end a square area of 2×2 cm, are used. This square area of a substrate element is coated with the adhesive/sealant to be tested. Four metals balls 2 mm thick are placed into the adhesive/sealant film as spacers. A second substrate element is then laid, with the same area, onto the adhesive/sealant and pressed together by hand until an adhesive/sealant film 2 mm thick (defined by the metal balls) is produced between the two substrate elements. Material emerging from the sides is removed with a spatula. The test articles are then held at 23° C. for varying times.

### Tensile Test—Performing the Measurement:

After the stipulated time, the test articles are elongated in an tensile tester until breakage. The maximum force value is determined, and an average value for each time unit is calculated from the three measurements.

Formulations according to Table 1 were produced with various polymers (see Table 2), the individual components having been produced by mixing in a Speedmixer (30 seconds):

TABLE 1
(formulations)

| | | Proportion in | Proportion in |
|---|---|---|---|
| | | component (1) | component (2) |
| Ingredient | Function | (parts by weight) | (parts by weight) |
| Polymer | Polymer | 29.7 | |
| Precipitated CaCO₃, | Filler | 5.5 | |
| coated with stearic | | | |
| acid (Socal 312) | | | |
| Natural CaCO₃, | Filler | 56.3 | |
| uncoated (Millicarb) | | | |
| Diisodecyl phthalate | Plasticizer | 7.0 | |
| Silyl-terminated | Reactive | | 93.6 |
| polyether (RD 359, | diluent | | |
| Kaneka) | | | |
| Bis(trimethoxysilyl- | Adhesion | 0.8 | |
| propyl)amine | promoter | | |
| (Trimethoxysilyl- | Adhesion | 0.8 | |
| propyl)butylamine | promoter | | |
| Vinyltrimethoxysilane | Water | 0.8 | |
| | scavenger | | |
| Water | Water | | 6.2 |
| Catalyst (TIB KAT | Catalyst | | 0.3 |
| 226, TIB Chemicals) | | | |
| Total | | 100.9 | 100.1 |

Components (1) and (2) were mixed at a weight ratio of 100:19.

Using compositions according to Table 1, the results listed in Table 2 below were obtained on the basis of two different polymers.

TABLE 2
Results as a function of polymer used

| | | | Formulation B (comparison, not |
|---|---|---|---|
| | | Formulation A (according to the | according to the present |
| | | present invention) | invention) |
| | Polymer | —O—C(O)—NH—CH₂—Si(OMe)₂Me- | —O—(CH₂)₃—Si(OMe)₃-terminated |
| | | terminated polyether (STPE 30, | polyether (SAX 580, Kaneka Co.) |
| | | Wacker Co.) | |
| Breaking force | Substrate | | |
| (N/mm²) | | | |
| after 3 days | PP/PP | 0.71 (cf) | 0.72 (cf) |
| | PC/PC | 0.77 (cf) | 0.65 (af) |
| after 7 days | PP/PP | 0.74 (cf) | 0.76 (cf) |
| | PC/PC | 0.68 (cf) | 0.75 (af) |
| after 3 days at | PP/PP | 0.9 (cf) | 0.92 (cf) |
| 100° C. | | | |
| | PC/PC | 1.0 (cf) | 0.66 (af) |

Polycarbonate (PC) used: Makrolon 2447 (Bayer)
Polypropylene (PP) used: Targor (Hoechst)
cf = Cohesive fracture (break within the adhesive layer)
af = Adhesive fracture (break between substrate and adhesive layer)

The agent according to the present invention consistently exhibits a cohesive fracture (break within the adhesive layer) in the tensile shear test, and therefore outstanding adhesion to the substrate. The tensile shear test with the formulation not according to the present invention, on the other hand, in several cases produced an adhesive fracture pattern (break between adhesive layer and substrate), thus indicating insufficient adhesion between the substrate and adhesive. The results therefore show that with the agent according to the present invention, in contrast to the formulation not according to the present invention, stable adhesive bonding of plastics can be carried out.

The formulations according to Tables 1 and 2 were used to carry out experiments to determine cohesion buildup. For this purpose, tensile shear experiments using polypropylene test articles (PP/PP) were carried out after 4, 6, 7, 8, 9, and 10 minutes. The results are summarized in Table 3 below:

TABLE 3
Results for cohesion buildup

| | Time (min) | | | | | |
|---|---|---|---|---|---|---|
| Breaking force (N/m²) | 4 | 6 | 7 | 8 | 9 | 10 |
| Formulation A | 2000 | 3000 | 4000 | 10,000 | 17,000 | 25,000 |
| Formulation B | 1000 | 2000 | 3000 | 4000 | 7000 | 13,000 |

The results show the faster cohesion buildup of the formulation according to the present invention.

What is claimed is:

1. A curable agent containing two components (1) and (2) that are not in mutual contact, wherein
component (1) contains at least one polymer having at least one terminal group of the general formula (I)
-Aₙ-CH₂—SiXYZ (I),
in which
A is a divalent bonding group containing at least one heteroatom,
X, Y, Z are substituents on the Si atom and, mutually independently, are C₁ to C₈ alkyl, C₁ to C₈ alkoxy, or C₁ to C₈ acyloxy residues, where at least one of the substituents is a C₁ to C₈ alkoxy or C₁ to C₈ acyloxy residue, and
n is 0 or 1; and
component (2) contains at least water and at least one silanol condensation catalyst.

2. The curable agent according to claim 1, wherein the divalent bonding group A in formula (I) is a carbamate group or urea group.

3. The curable agent according to claim 1, wherein X, Y, Z in formula (I) are, mutually independently in each case, a methyl, an ethyl, a methoxy, or an ethoxy residue.

4. The curable agent according to claim 1, wherein the —SiXYZ group of formula (I) is a methyldimethoxysilyl group.

5. The curable agent according to claim 1, wherein the polymer of component (1) comprises at least one terminal group of the formulas —O—CO—NH—CH₂—Si(OMe)₂Me or —N(R¹)—CO—NH—CH₂—Si(OMe)₂Me, in which R¹ denotes a hydrogen atom or an alkyl group having 1 to 8 carbon atoms.

6. The curable agent according to claim 1, wherein the total content of polymers having at least one terminal group of formula (I) is 5 to 50 wt %, based on the total weight of the agent.

7. The curable agent according to claim 1, wherein the polymer of component (1) is a polyether.

8. The curable agent according to claim 1, wherein the agent contains
in component (1)
a. 10 to 40 wt % polymer having at least one terminal group of formula (I),
b. 30 to 70 wt % filler,
c. 5 to 30 wt % plasticizer,
d. 0 to 10 wt % adjuvants, and
in component (2)
e. 0 to 50 wt % filler,
f. 30 to 95 wt % plasticizer,
g. 1 to 10 wt % water,
h. 0.05 to 2 wt % silanol condensation catalyst,
i. 0 to 5 wt % further adjuvants,
wherein the “wt %” indications being based in each case on the total weight of the corresponding component, and the proportions of the ingredients in the two components each adding up to 100 wt %.

9. An adhesive or sealant comprising the curable agent according to claim 1.

10. A thermoplastic substrate bonded by cured reaction products of an adhesive or sealant comprising the curable agent according to claim 1.
